(19) United States
(12) Patent Application Publication
(10) Pub. No.: US 2025/0384394 A1
(43) Pub. Date: Dec. 18, 2025

(54) IMPROVED CONSTRUCTION SYSTEM

(71) Applicant: Emagineer Pty Ltd., Beaumaris (AU)

(72) Inventors: Keira Czarnota, Beaumaris (AU); Finbar O'Hanlon, Port Melbourne (AU)

(73) Assignee: Emagineer Pty Ltd., Beaumaris (AU)

(21) Appl. No.: 18/995,287

(22) PCT Filed: Jul. 18, 2023
(86) PCT No.: PCT/AU2023/050658

§ 371 Date: Jan. 16, 2025

(30) Foreign Application Priority Data
Jul. 18, 2022 (AU) 2022902006

(51) Int. Cl. G06Q 10/0875

(52) U.S. Cl. CPC G06Q 10/0875

(57) ABSTRACT

A system for generating a set of procedures for building a model with a set of inventory parts, the system comprising a processor for carrying out the steps of: receiving a digital representation of an object; applying an image recognition algorithm to detect one or more objects from the digital representation; conducting artificial classification algorithm to classify each of the objects into a predetermined assembly, wherein the predetermined assembly is associated with a set of predetermined parts with a set of predetermined procedures; determining a set of modification parts for the predetermined assembly; substituting the set of modification parts with one or more inventory parts; and generating a set of procedures by updating the set of predetermined procedures in accordance with the inventory parts.

### TECHNICAL FIELD

The present invention relates to object detection, object recognition and designing and generating a set of procedures for building a model based on inventory parts.

### BACKGROUND

Reusable kit of parts system is becoming popular in many walks of life, for example: in constructions of building, electronics, and even in recreation model building. Typically, a user acquires a set of the kit of part system for one purpose and there is provided a dedicate instruction manual to assembly the toy construction elements into a kit of that purpose.

The user late may disassemble the kit and apply imaginations and make another creation out of the elements in the user's inventory. These creations made are sometime referred to My Own Creation (“MOC”). These are creations typically have been designed and built by the general public owners (“Fans”) of the kits of parts using the original elements from the official kits. These Fans sometime release images and instructions of their MOC such that others may repurpose the kit of parts they owned.

Designing an MOC typically takes a lot of planning and work. For example, six 2×4 rectangular construction elements can be combined in more than 915 million ways. And there may be 3700 different kinds of construction toy elements in one single brand of construction kit.

U.S. Pat. No. 10,596,479 discloses a software for generating a digital representation of a user-defined construction element connectable to pre-manufactured toy construction elements of a toy construction system. The pre-manufactured toy construction element comprising a number of coupling elements for coupling other pre- manufactured toy construction elements. The software comprising a method for determining one or more positions for placement of one or more coupling elements to be included in the user-defined construction element. Then, the software generates, responsive to input by a user indicative of a user-defined shape, a digital representation of a user-defined construction element. This user-defined construction element comprising one or more coupling elements at the determined one or more positions. The software then provides the digital representation for automated production of said user-defined construction element.

While it is attractive and stimulates users' creativity, it is difficult for beginners to make a complicated 3D work without any references. There has been proposal of a technique for generating an assembly manual of 3D block artwork automatically from a 3D polygonal model. Ono, S., Andre, A., Chang, Y., Nakajima, M.: LEGO builder: automatic generation of an assembly manual from 3D polygon model. ITE Trans. Media Technol. Appl. 1 (4) 354-360 (2013) proposed system or method a method that converts 3D polygonal models into assembly instructions automatically. The researchers introduced a graph structure named “legograph” that would allow researchers to generate physically sound models that do not fall apart by managing the connections between the bricks. However, this method did not take into account the material or construction elements that were available to a user and did not allow a user to re-define different sets of construction elements to build the 3D model.

In Santos, T., Ferreira, A., Dias, F., Fonseca, M.J.: Using sketches and retrieval to create LEGO® models. In: Proceedings of the Eurographics Workshop on Sketch-Based Interfaces and Modeling 2008 (SBIM'08), pp 80-96, it discloses a system to create LEGO® models using sketches. This system was similar to other LEGO® applications, such as, the MLCAD, LeoCAD, and BrickLink's Studio which assists uses to model a LEGO® assembly in a software environment. The system discloses in this research paper applies a retrieval technique that uses sketches to specify the characteristics of the part to locate. Search results are presented in a suggestion list, organized by categories. This in combination with a calligraphic interface to manipulate parts and the camera produced an application. However, these kinds of applications do not allow a user to create a 3D model from a 2D sketches and the system does not take into consideration of the user inventory.

Any discussion of the prior art throughout the specification should in no way be considered as an admission that such prior art is widely known or forms part of common general knowledge in the field.

### SUMMARY

### Problems to be Solved

It may be an advantage to have a system or process generate instructions for building a model from a variety of different received data inputs.

It may be an advantage to have a system or process that could be used in the development of bespoke LEGO® models.

It may be an advantage to have a system or process that have a detection program that is trainable for improving object detection.

It may be an advantage to have a system or process that when an animate object is received in the data input, the system or process can generate instructions for building a moving model.

It may be an advantage to have a system or process that have a program that allows and identifies substitute pieces or building elements that could construct the model based on an inventory of parts.

It may be an advantage to have a system or process that can allow a model to be created based on user inventory of parts.

It may be an advantage to have a system or process that allows a user to register and input to the system the user's available building block or building elements.

It may be an advantage to have a system or process that allows multiple users to register and input to the system each individual user's available building block or building elements, and that the system can generate instructions for building a model if one or more users are building together based on their collective inventory of parts, or that the system can generate instructions for building a model individually based on one's own inventory of parts.

It may be an advantage to have a system or process that is integrable with a virtual reality headset.

It may be an advantage to have a system or process that can recognise and detect facial features from a data input and generate a minifigure that resembles the received person's image.

It may be an advantage to have a system or process that have privacy settings when received person's image had been detected by the recognition program.

It may be an advantage to have a system or process that can create a building block model of an object, in which the model can be communicated into a virtual reality setting.

It may be an advantage to have a system or process that can recognise and select virtual reality objects for the system to generate instructions to create a buildable model based on the inventory of parts.

It may be an advantage to have a system or process that can associate or estimate specific MOC model or any 3D model or asset based on user tracking and behaviour.

It may be an advantage to have a system or process that allows for applying a unique identifier into the container of the model in an unreserved space. And it may be an advantage to expand the capability of existing MOC libraries by extending MOC functionality to accommodate trending and tracking information.

It is an object of the present invention to overcome or ameliorate at least one of the disadvantages of the prior art, or to provide a useful alternative.

### Means for Solving the Problem

A first aspect of the present invention may relate to a system for generating a set of procedures for building a model with a set of inventory parts, the system comprising a processor for carrying out the steps of: receiving and a digital representation of an object; applying an image recognition algorithm to detect one or more objects from the digital representation; conducting artificial classification algorithm to classify each of the objects into a predetermined assembly, wherein the predetermined assembly is associated with a set of predetermined parts with a set of predetermined procedures; determining a set of modification parts for the predetermined assembly; substituting the set of modification parts with one or more inventory parts; and generating a set of procedures by updating the set of predetermined procedures in accordance with the inventory parts.

Preferably, the step of determining the set of modification parts comprises a step of identifying one or more predetermined parts not in the set of inventory parts.

Preferably, the step of determining a set of modification parts comprises the steps of: identifying one or more deviation sub-assemblies of the predetermined assembly; calculating a deviation sub-assembly value of each of the deviation sub-assemblies; adding a deviation sub-assembly in the set of modification parts when the deviation distance value of the deviation sub-assembly exceeds a threshold value.

Preferably, the step of substituting the set of modification parts comprises the steps of: connecting to an inventory database storing one or more inventory assemblies, wherein each of the inventory assemblies is associated with one or more inventory parts for building one or more inventory sub-assemblies in association with a set of inventory procedures; conducting local classification algorithm to classify each of the modification parts into an inventory sub-assembly; determining the inventory parts and a set of procedures for building the inventory sub-assembly.

Preferably, the local classification algorithm comprises an unsupervised artificial neural network classification algorithm.

Preferably, the local classification algorithm comprises a decision tree classification algorithm.

Preferably, the inventory sub-assembly comprises one or more parts.

Preferably, the inventory database is populated with user data by an end user.

Preferably, the system comprises a server-side database for storing predetermined assembly, predetermined parts, and predetermined procedures.

Preferably, the server-side database is populated by a service provider.

Preferably, the step of generating a set of procedures comprising the step of replacing a set of predetermined procedures associated with the modification parts with a set of inventory procedures associated with the inventory parts.

Preferably, the object is animate, the processor further carries out the step of applying a motion pattern algorithm to detect and store movement of one or more animate objects prior to conducting artificial classification algorithm to classify each of the animate objects into a predetermined assembly.

Preferably, the processor is in communication with a Virtual Reality module.

Preferably, the object is a virtual reality object, wherein the processor can carry out the step of applying a vision pattern algorithm to detect one or more virtual reality objects.

Preferably, the virtual reality object is animate, the processor applies a motion pattern algorithm to detect one or more virtual reality animate objects.

Preferably, the processor can carry out the step of generating the set of procedures for building the model from the predetermined assembly of the virtual reality object.

Preferably, the inventory database is populated with user data by a first end user and a second end user, for when the first end user and the second end user to build the model based on collective inventory parts.

Preferably, the inventory database is populated with user data by a first end user and a second end user, wherein the system generates a set of procedures for building a first model for the first end user and for building a second model for the second user based on inventory parts of the first end user and the second end user respectively.

A second aspect of the present invention may relate to a system for generating a virtual representation of a predetermined assembly of a model from an object from reality into virtual reality, the system comprising a processor for carrying out the steps of: receiving and conducting pre-processing of a digital representation of the object from reality; applying a vision pattern algorithm to detect one or more objects from the digital representation; conducting artificial classification algorithm to classify each of the objects into a predetermined assembly, wherein the predetermined assembly is associated with a set of predetermined parts from one or more inventory parts; determining a set of modification parts for the predetermined assembly; and connecting to a virtual reality module, wherein the predetermined assembly of the model by the one or more inventory parts is uploaded to the virtual reality module.

Preferably, the object from reality is animate, the processor applies a motion pattern algorithm to record and detect the movement of the one or more animate objects.

Preferably, the object is detected by the vision pattern algorithm to be a person, the predetermined assembly of the model is an avatar.

Preferably, the object is detected by the vision pattern algorithm to be a person, the processor is configured to carry the step of connecting to an identity database storing user image data, wherein the processor is configured to cross-reference the user image data with the identity database for determining authorised usage of the avatar.

Preferably, when the image of the person does not match the user's image, the processor is configured to carry out the step of seeking user authorisation of the person's image.

Preferably, when the user has permission to use the person's image, the processor can carry out the step of generating the avatar of using the person's image.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts an improved construction system for generating assembly procedures in according to a preferred embodiment of the present invention.

FIG. 2 depicts a schematic diagram showing a first phase functional process when it is a Sketch to Build Process.

FIG. 3 depicts another schematic diagram showing the first phase functional process when it is a Sketch to Build Process of FIG. 2, in which the process can also extend to utilising 3D Augmented reality.

FIG. 4 depicts a schematic diagram showing a first phase functional process, in which the process starts in a Face Photo to Build Process.

FIG. 5 depicts a schematic diagram showing a second phase functional process, in which the substitution AI engine evolves through further training, into the Build AI engine capable of generating builds without using an existing MOC as a starting point.

### DESCRIPTION OF THE INVENTION

Preferred embodiments of the invention will now be described with reference to the accompanying drawings and non-limiting examples.

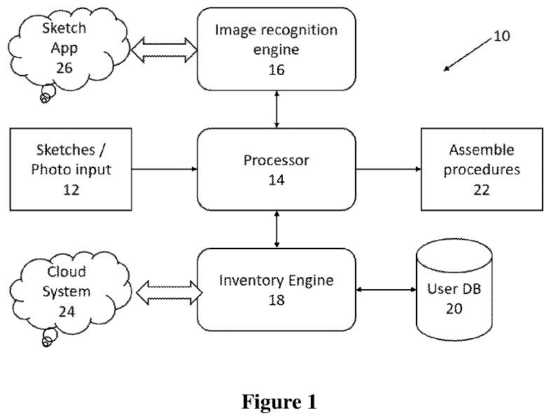

In an embodiment of present invention as shown in FIG. 1, in the sketch to build process, the system 10 may generate a set of procedures for building a model 22 with a set of inventory parts or construction elements stored in the user database 18. The construction elements or inventory parts may be for example but not limited to LEGO® bricks, LEGO® DUPLO® bricks, MINIFIGURES® etc. The system 10 may comprise a processor 14 for carrying out a step of receiving and conducting a pre-processing of a digital representation of an object 12. The processor 14 may be in communication with one or more applications 22 such as Google Quickdraw, Sketchup, and Tensorflow 2 for user sketch recognition and for utilising the core Artificial Intelligence (AI) functions or image recognition algorithms provide by the image recognition 16 of the system 10. In another embodiment, the user may import the object from files generated by other design and modelling software, such as AutoCAD, Solidwork, Photoshop, Paint, etc.

In one embodiment, the processor 14 is adapted to receive the digital representation via a user provided sketch when sketched directly in a sketching user interface 12. Alternatively, the user may open a sketching user interface 12 and take a photo of their sketch, if not sketched directly in the application. In one embodiment, the sketching user interface 12 comprises a digital drawing board or drawing tablet adapted to allow a user to directly drawing on such device using finger or digital stylus pen. In another embodiment, the sketching user interface 12 comprises a digital camera. In yet another embodiment, the sketching user interface 12 comprises a 3D camera system for taking image in 3D format.

The processor 14 may then conduct pre-processing of the digital representation of the object when sketched or a photo of the sketch was provided. The processor 14 may pass the image or digital file to the image recognition engine 16 to execute a vision pattern algorithm to detect one or more objects from the digital representation.

In one embodiment, the image recognition engine 16 is adapted to carry out an image recognition algorithm. The image recognition engine 16 may comprise one or more artificial intelligence engine adapted to conduct pattern recognition and/or object classification. In one embodiment, one of the artificial intelligence engines comprises an unsupervised artificial neural network for classification. The image recognition engine 16 may comprise artificial intelligence engine to carry out a decision tree classification algorithm for identify the object and matching the predetermined assembly. The image recognition engine 16 may be trained to recognise the sketches or input specific to the local users or to a particular individual user. The image recognition engine 16 may be trained to classify and match the sketch to a specific set or subset of predetermined assembly. In one embodiment, the image recognition engine 16 may comprise an AI engine trained for matching animals and another AI engine trained for matching vehicles.

The image recognition engine 16 may identify and determine the object that the user had sketched directly. While user provided sketches are roughly drawn and differs from user to user, the image recognition engine 16 may be trained through user sketches over time identifying and associating similar shapes to a certain object.

The image recognition engine 16 may find or classify a matching predetermined assembly that is closest to the objects presented in the digital representation provided by the user. The predetermined assembly may be one from the pre-existing official construction models or from the My Own Creation (MOC) models. These models may be stored on the Internet in a cloud system 24. That is, for example, when the user may have provided a rough sketch similar to a car, which may be a 2D or a 3D sketch, the image recognition engine 16 may recognise that the object sketched is a car and identify a predetermined assembly that is closest match to that car. The predetermined assembly is associated with a set of predetermined parts with a set of predetermined procedures to build that predetermined assembly.

In one embodiment, the image recognition engine 16 may determine whether the predetermined assembly is a close enough match to the object. The image recognition engine 16 may generate one or more distance measures between the object and the predetermined assembly. In one embodiment, the object is a 3D digital object.

If the distance measures are within the range of one or more tolerant threshold values, then the processor 14 will accept the predetermined assembly. Otherwise, the processor 14 will conduct modification algorithm to determining a set of modification parts for the predetermined assembly for modifying one or more part of the predetermined assembly to archive better distance measures. In one embodiment, the image recognition engine 16 is adapted to divide the object into a plurality of sub-region and generate distance measures for each sub-region. The image recognition engine 16 is adapted to find a closest match sub-assembly from other predetermined assembly or MoC model to substitute a set of modification parts with one or more inventory parts for the mismatched sub-region.

Once a closest predetermined assembly is identified, the processor 14 then passes the process to the inventory engine 18 to determine whether the parts for the predetermined assembly are in the user inventory. A lot of the previous applications do not take into consideration that certain parts are not available to the user. In particular, some parts may be exclusive to an expensive set the user may not possessed. Some parts may belong to the retired set that is now difficult to acquire. The inventory engine 18 will identify the parts that are not available to the user. In another embodiment, the user may define a particular sub-set of parts for the project. For example, the user may limit the build to technical construction elements or exclude the technical construction elements completely.

The inventory engine 18 is adapted to make a decision for substituting based on the user's inventory of parts and/or an artificial substitution algorithm (substitution AI) that may determine integral pieces or essential pieces from superficial pieces, in which the superficial pieces can be substituted for another similar shaped piece available in the inventory of parts.

The step of determining the set of modification parts may comprise a step of identifying one or more predetermined parts not in the set of inventory parts. The step of determining the set of modification parts may comprise the steps of: identifying one or more deviation sub-assemblies of the predetermined assembly, calculating a deviation sub-assembly value of each of the deviation sub-assemblies, and adding a deviation sub- assembly in the set of modification parts when the deviation distance value of the deviation sub-assembly exceeds a threshold value.

Once the parts in the inventory of parts are determined by the processor 14 to be able to build the model resembling the user sketch, the processor 14 then generates a set of procedures or build instructions for the user to follow. The processor 14 first obtains the procedures or build instruction associated with the predetermined assembly. Then, the process 14 identifies the parts that has been modified and the associated procedures. Then, the processor 14 replaces those associated procedures and generate replacement or substitute procedures accordingly.

The set of procedures may be a step-by-step guide showing or conveying to a user how a piece or a building element are arranged and connected, in which following the set of procedures will ultimately create the preassembled assembly of the model.

In another embodiment of the present invention, the step of substituting the set of modification parts may comprise the steps of: connecting to an inventory database 20 storing one or more inventory assemblies. Each of the inventory assemblies may be associated with one or more inventory parts for building one or more inventory sub-assemblies in association with a set of inventory procedures. The processor 14 may conduct a local classification algorithm to classify each of the modification parts into an inventory sub-assembly and the processor may determine the inventory parts and a set of procedures for building the inventory sub-assembly. For example, using the sketch of a car as an example, the predetermined sub-assemblies may be identified as a collection of regions that are connected to form the model of a car. The sub-assemblies may be for example, at least comprising of a chassis, a bonnet, a trunk, and wheels etc with connecting pieces between the sub-assemblies that forms the buildable model of the car.

The inventory database 20 may be populated with user data by an end user. The end user may manually input their inventory of construction elements. The input may be a list of model kits owned by the user and/or one or more photographs of assembled models and/or loose building elements in the user's possession. The user entry in the inventory database 20 may comprise registering the user with a host service managing the inventory database to facilitate access for the user to enter their building elements or inventory of parts. The step of receiving the list of model kits may comprise receiving a code or a QR code or name identifying the model kit. The step of receiving the one or more photographs of assembled models and/or loose building elements may comprise uploading the one or more photographs to the host service. The step of generating the building elements present in said list of model kits may comprise accessing a historical database of model kits to identify the model kit that matches the received code or name and downloading the list of building elements present in the model kit. The step of generating an inventory list of all identified building elements may comprise sending one or more received photographs of assembled models to the image recognition engine 16 to identity a model kit used to build the assembled model and downloading the list of building elements present in the model kit. The step of updating the inventory list each time the user obtains a new model kit and/or new building elements may comprise identifying the new model kit and/or new building elements and adding the list of new building elements to the inventory list stored in the database 20.

In another embodiment of the present invention, there is provided a system 10 for generating a set of procedures for building a model based on an image of a subject or object present in a still or moving image, which are digital representation of a moving object. Similarly, the processor 14 may be configured to receive the still or moving image, in which the moving subject or moving object may be identified from the received still or received moving image. In one embodiment, the sketch user interface 12 comprises a video camera or high speed video camera for taking motion pictures.

The processor 14 may then conduct pre-processing of the digital representation of the moving object. The processor 14 send the processed digital representation to the image recognition engine 16 to detect one or more objects from the digital representation, in which the image recognition engine 16 may have a detection AI which may also map objects detected in the moving image and then may map the moving objects to a My Own Creation (MOC) Model sub dataset.

In one embodiment, the image recognition engine 16 classified the processed digital representation into an object. The recognition engine 16 may comprises a number of sub-AI engine for matching a predetermined assembly for the object. Each of the sub-AI engine may be trained to match a specific type of objects. The image recognition engine 16 will send the object to the corresponding sub-AI engine for matching.

Similarly, the image recognition engine 16 may then conduct artificial classification algorithm to match each of the moving objects into a predetermined assembly, in which the predetermined assembly will comprise the construction elements that allows certain regions or parts, when joined, to move relative to each other for mimicking the movement or as close to the natural movement of the received moving image. That is, for example, when the user may have provided a moving image of a car with openable doors, the classification algorithm may classify into a vehicle object. The image recognition engine 16 may the find a predetermined assembly that has the closest association to the digital representation or the object.

This process may involve the association with a set of predetermined parts with a set of predetermined procedures to build the intended movable object from the moving image. The set of predetermined parts with a set of predetermined procedures may be from an existing predetermined assembly of similarly movable objects or regions is in the predetermined assembly database or inventory. Similarly, the model and instruction data sets will be combined under the MOC file type where movable models and instructions are combined.

It may be appreciated that similarly, the processor 14 may determine a set of modification parts for the predetermined assembly of the movable object. And the processor 14 may substitute the set of modification parts with one or more inventory parts relating to immovable parts and/or alternative movable parts. Similarly, the decision for substituting may be based on the user's inventory of parts and/or an artificial substitution algorithm (substitution AI) that may determine integral pieces or essential pieces from superficial pieces, in which the superficial pieces can be substituted for another similar shaped piece or alternate movable parts that may be available in the inventory of parts. In a similar way, the step of determining the set of modification parts may comprise a step of identifying one or more predetermined parts not in the set of the inventory of parts. The step of determining the set of modification parts may comprise the steps of: identifying one or more deviation sub-assemblies of the predetermined assembly, calculating a deviation sub-assembly value of each of the deviation sub-assemblies, and adding a deviation sub-assembly in the set of modification parts when the deviation distance value of the deviation sub-assembly exceeds a threshold value. Once the parts in the inventory of parts are determined by the processor to be able to build the movable model resembling the movable image, the processor then generates a set of procedures or build instruction for the user to follow. The set of procedures may be a step-by-step guide showing or conveying to a user how a piece or a building element are arranged and connected, in which following the set of procedures will ultimately create the preassembled assembly of the movable model.

In another embodiment of the present invention, a system of generating an individual LEGO® avatar for a user, when the image recognition engine 16 has detected and classified that the object or moving object is a person or from recognising that the image have facial features. The processor 14 may notify the user take a photo of their image via a camera from the user's electronic device. The device may be the user's smartphone or the user's personal computing device, in which the application can allow a user access to the camera to directly take a photo or retrieve selected saved photos from the photo album when given user access. When the system 10 has received the photo from the user, the image recognition engine 16 may have a sub-AI engine configured to analyse features of the person present in the received photograph. The image recognition engine 16 may recognise individual characteristics or distinctive features of the person's face/head/body, such as hair colour, hair style, eye colour, eye shape, etc. The processor 14 may be in communication with any number of known programming interfaces that may employ facial recognition and feature capture referring data in the cloud system 24 or the user database 20. The processor 14 may be able to convert these recognised characteristics or distinctive features into a head avatar of the person as well as an instruction module and building elements listing for creating the person's body if required. For a buildable model, the processor 14 may generate a set of procedures for building the avatar of the person as a model using the set of inventory parts, in which the model may be immovable or a movable model, and these models are constructable mosaic, MINIFIGURES® or Brickheadz™ for play and/or display purposes. As such, through this system 10, the user can have an electronic block version of person as well as a physical buildable form or block version made from building elements. The building elements or inventory of parts may be commercially available from the LEGO® store, or from the user's existing inventory of parts. In another embodiment, the system 10 may create the model and instructions for construction elements other than LEGO® kit of part system.

It may be appreciated that for improving the privacy of persons received by the system 10, the processor 14 may be configured to carry the step of connecting to an identity database or user database 20 which may store at least the user image data. The processor 14 may be configured to cross-reference the user image data with the identity database or user database 20 for determining authorised usage of the avatar.

When the image of the person does match the user's image from the user that had registered with the host service for managing the user database 20, the processor 14 allows the user to use the image to convert into a head avatar of the person. When the image of the person does not match the user's image from the user that had registered with the host service for managing the inventory database, the processor 14 may carry out the step of seeking user authorisation or permission to allow the user to use the image that is not of themselves. If user authorisation or permission is not provided, the processor 14 may not progress to creating a head avatar. However, if user authorisation of permission is provided, the processor 14, which may be in communication with an image recognition engine 16 and proceed to identify the person and create a head avatar that match as closely as possible to the person being photographed, as well as optionally, generating a set of procedures and building elements listing for creating the person's body.

In a preferred embodiment of the present invention, the first phase of development is that the process carried out by the system 10 will construct personalised LEGO builds by modifying predetermined assembly or other My Own Creations (MOCs) that exist in the use database 20 or cloud system 24. These predetermined assemblies will be customised by the image recognition engine 16, and refined by the inventory system 18 based on the bricks the user owns and/or from a user defined set of construction elements.

In one embodiment, the AI engine of the image recognition engine 16 requires training to improve the accuracy in matching a predetermined assembly. A user may collect a number of specific assemblies, such as cars, animals, building, etc for training the AI engine.

Over time, through user usage and input, the database of builds grows, and through on-going training, the image recognition engine 16 will be capable of recognising difficult sketch. In another embodiment, the image recognition engine 16 may learn to generated an assembly instead of classifying an object into a predetermined assembly as a starting point.

The initial builds will be human built MOCs which will be created pre-launch commissioned from MOC designers who will building using stud.io or BrickLink Studio 2.0 which supports direct integration with BrickLink's catalogue, marketplace, and gallery. Or it can be sourced from marketplaces such as rebrickable.com which allows a user to reuse your old LEGO® bricks to find and build new creations. The MOC dataset will be generated by looking at trending categories and individual requests which may be sourced from at least one from the group of: Dubit Trends research data, informing popular children's brands, interests, and hobbies; direct surveys of users (such as children), and analysis of popular builds on LEGO® Life. These will be cross-referenced with the objects that quick draw data set so that detection rate remains high which may give a better user experience. The user experience may be designed so as the experience will not seem limited to a user due to the capability of the AI.

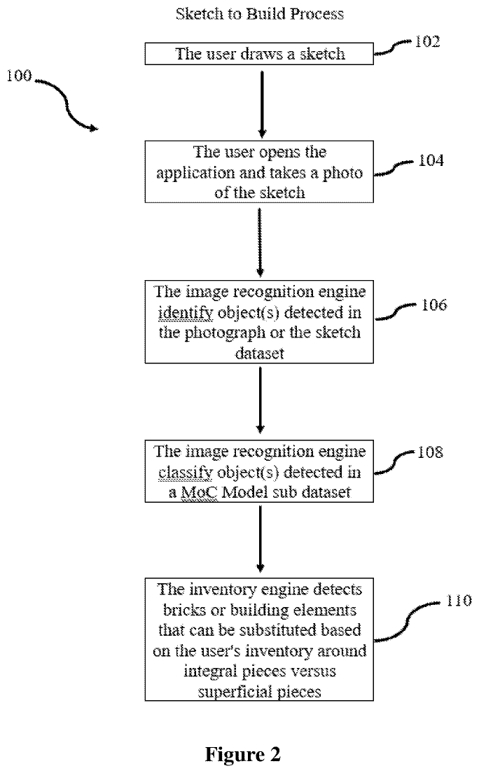

In one embodiment, as shown in FIG. 2, the first phase functional process when it is a Sketch to Build Process, the system 100 may carry out the following steps: 1. The user draws a sketch 102; 2. The user opens the application or app and takes a photo of their sketch 104; 3. The image recognition engine 16 identify object(s) detected in the photograph or the sketch dataset 106; 4. The image recognition engine 16 classify object(s) detected into a MOC Model sub dataset 108; 5. The inventory engine 18 then detects bricks or building elements that can be substituted based on the user's inventory and/or heuristics around integral pieces versus superficial pieces 110.

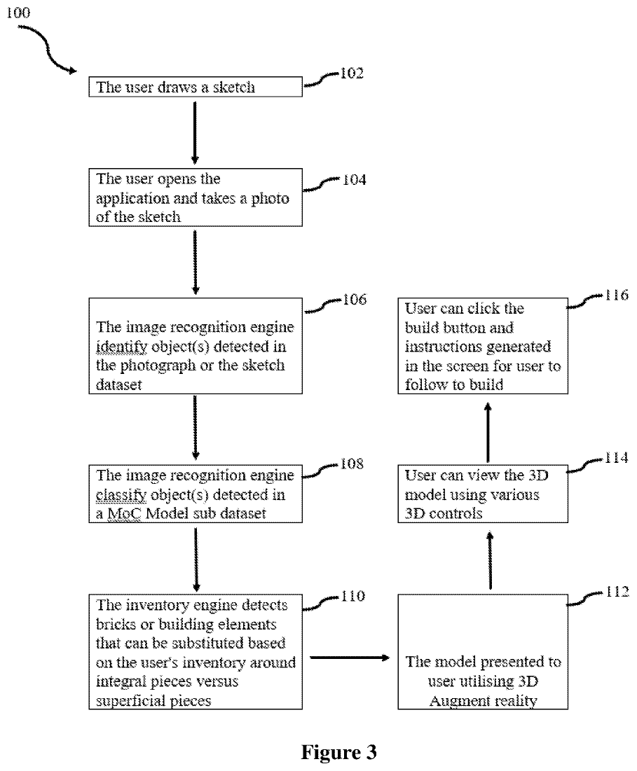

As shown in FIG. 3, the steps may further comprise: 6. The model may be presented to the user utilising 3D Augment reality 112; and in this 7. the user can view the 3D model using various 3D controls 114; 8. The user may then click the build button and the instructions are generated in the screen for the user to follow to build 116.

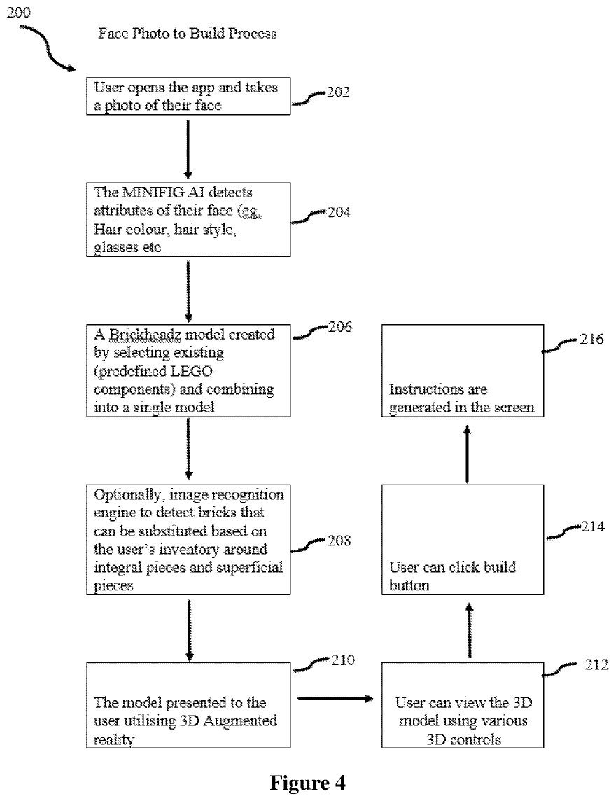

In another embodiment, as shown in FIG. 4, the first phase functional process starts in a Face Photo to Build Process, the system 200 may carry out the following steps: 1. User opens the app and takes a photo of their face 202; 2. The MINIFIG AI may detect attributes of their face, eg. Hair colour, hair style, glasses, etc 204; 3. A Brickheadz model may be created by selecting the existing (predefined) LEGO® components (eg. Short brown hair style and/or the type of smile) and combining into a single model 206. Optionally, step 4 may use image recognition engine 16 to detect bricks that can be substituted based on the user's inventory and heuristics around integral pieces versus superficial pieces 208. 5. The model may be presented to the user utilising 3D Augmented reality 210; 6. User can view the 3D model using various 3D controls 212; 7. User may click build button 214 and then the instructions are generated in the screen 216.

It may be appreciated that similar functional process for generating MINIFIGURES, however output is minifig ‘stickers/emojis’ that can be used in social apps.

In one embodiment, the foundational process may use the Google QuickDraw and Tensorflow 2 for assisting the image recognition engine 16 to identify the objects.

### ML Components in Emagineer First Phase

Minifig AI—the image recognition engine 16 may be trained to recognise the user's face and may suggest instructions for creating minifigs or brickheadz model that match as closely as possible to the person being photographed. In another embodiment, the system 10 may use Google QuickDraw as an application to detect what a user has drawn and then pass the result to the image recognition engine for classifying or matching the recognised objects to one or more MOCs.

In one embodiment, Google's quickdraw is trained on a specific data set which matches a lot of things that will be popular for kids to draw. For example, cars, horses, people, houses, etc. This makes it immediately useful to look up models that match those types, however, this is more limited than a builder's imagination and subsequently won't match all the types of MOCs that get created. The accuracy and libraries of the AI engines from the image recognition engine 16 or third party system can be further developed through more user input regarding sketch and photos on an ongoing basis.

For inventory matching, the process 14 and the inventory engine 18 may match inventory pieces that can replace the substitutable pieces suggested by the substitution AI. For example, when the inventory engine 18 keep tracks of the pieces or the building elements of the user's inventory of parts, the processor 14 would have built this for the user.

For Substitution AI—the image recognition engine 16 and the processor 14 may recognise pieces that can be substituted in a given MOC with other pieces from a LEGO® set and will create a new MOC based on that. In one embodiment, the image recognition engine 16 comprises a specialised substitution AI engine that works as both a tool outside of the app to build a larger data set and in the app to suggest further variations. Whilst each component has its own function, each one of them makes decisions using Machine Learning to identify a different part or region and replace a closer match. When some models, for example, substitution AI engine, become proficient enough to create their own MOCs, they can be used to generate data sets to enhance the current version of the app whilst training further models for the next version of the app.

Other components of the first phase may include inventory capture. This process requires user data input to let the processor 14 know which pieces or building elements that the user has. By capturing the user inventory, it may be inputted by human entering set numbers; or photographing QR codes on LEGO® boxes.

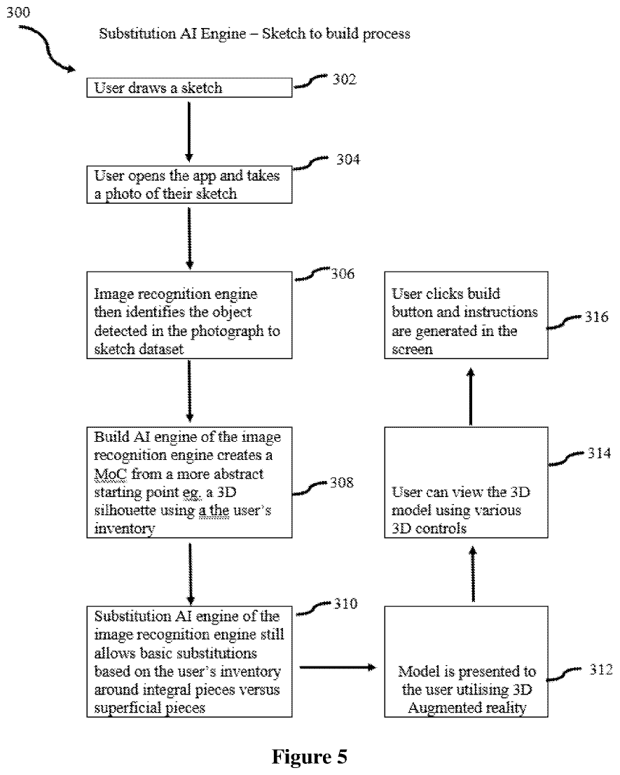

In phase 2, the substitution AI engine evolves through further training, into the Build AI engine capable of generating builds without using an existing MOC as a starting point. It may be appreciated that for the purposes of this document, the Build AI engine is an evolution of the Substitution AI engine. However, both are referenced separately for clarity of function. As shown in FIG. 5, the functional process of Phase 2 in the sketch to build process 300 may comprise the following steps: 1. The user draws a sketch 302; 2. The user opens the app and takes a photo of their sketch 304; 3. The image recognition engine 16 then identifies the object detected in the photograph to sketch dataset 306. Phase 2 will have a larger data set and therefore higher fidelity matches to what the users have imagined and/or put onto the sketch; 4. Build AI engine of the image recognition engine 16, creates a MOC from a more abstract starting point, for example, a 3D silhouette, using the user's inventory 308; 5. Substitution AI engine of the image recognition engine 16 still allows basic substitutions based on the user's inventory and heuristics around integral pieces versus superficial pieces 310; 6. Model is presented to the user utilising 3D Augmented reality 312; 7. User can view the 3D model using various 3D controls 314; 8. User clicks build button and instructions are generated in the screen 316.

Machine Learning (ML) Components in Phase 2. Build AI engine (evolved Substitution AI engine) and Detect AI engine extended. The Build AI engine is able to further customise the model to be built and eventually generate custom build instructions. This will also be a tool outside of the App to generate a larger MOC dataset and inside of the app to suggest real-time variations. The Build AI engine will also be capable of creating full instruction sets for newly generated models. The Detect AI engine extended is a further extension of the Detect AI engine which will be able to match against a wider set of inputs by further training Google Draw and smart indexing of the instruction data. Photodetection of non-sketched objects will be another direction that the detection AI will be extended. As part of the process, it may be preferred to have a set of tools or software that may verify and augment the data set around fundamental piece data categorisation.

Using the tree node data structure model as an example, if LEGO blocks are used, the LEGO pieces provide a methodology similar to a tree model. The root node are considered core foundational blocks, in which the root node is the lowest level that things connect to. The branch node may be considered object or structure shape. The branch node may be considered pieces that connect to the root node that form the overall shape of the object/model. The leaf node in the data structure model may be considered as individualised variations or object detail. That is, the pieces that embellish the model.

It may be appreciated that in this system, the Minifig (face detection) AI is separate from the drawing detection program/software. When drawing/sketches are detected by the drawing detection AI, the drawing detection AI will initially start out as the Google QuickDraw with the standard dataset but will over time have to be extended and trained to move beyond the limits of what it can recognise to date. The process will also cross-reference with what the Google QuickDraw can do contemporarily, which may be usually for simple objects that users can draw. It may also be appreciated that while the matching and inventory input is a set of algorithms to begin with, that this AI program can be trained and will evolve into smarter AI systems. The substitution AI program may be first evolution of the AI and will help build the data set up as a tool outside of the app and also be used in the app. The Build AI will help create even more custom MOCs in time that are beyond colour (for integral pieces) and piece substitution (for superficial pieces). It may be appreciated that through more data input and training, the AI can be refined or evolved to better predict any of the functional processes.

While the process can generate instructions for building a model from a variety of sources including photograph, data or API connected inputs. In this concept, a number of different data inputs could be used in the development of LEGO models as opposed to a photograph.

In one preferred embodiment, applications and uses for this system may be integrable into the Metaverse, where a user's location inside the metaverse, for example, if at a virtual concert could trigger specific merchandise items based on the performer on stage at the concert in which the process could generate instructions for building the Artist LEGO model.

In another preferred embodiment, where live data input could be used to animate models or make the models come to life in other ways. For example, a user may use their Metaverse glasses such as RayBan/Facebook glasses or a Virtual Reality (VR) KIT with glasses and hand controls to connect to Emagineer. The glasses may have the capability to record short videos. And these devices may feed the recorded video into the Emagineer technology. The Emagineer technology may react to this live input by allowing a mapping interface whereby movement can be mapped to an object to bring the object to life or to aid in the development of models. In certain scenarios, people with disability could use these devices to aid in cognitive development through different building interfaces. In other scenarios, the live input devices could be used in training.

In another preferred embodiment, where a scenario may involve multi or multiple users such as two users sharing a building session could have both their sets or parts scanned, with both their favourites input in to combine into a consolidated term set of recommendations. In a multi user scenario, the system 10 could also accommodate a method where challenges could be put forward by a master challenge server and teams are assembled based on building skill or favourites. In these examples, multiple source input data streams would be required in building a rich building environment not solely focused on a user's existing brick inventory, stored preferences or manual selection.

In another concept, the Emagineer technology or processors would build a MOC extension where user tracking and behaviour could be directly associated with a Specific MOC model or any 3D model or asset, whether that asset be used in video games, social scenarios, or in the Metaverse. As the world uses more and more 3D models to represent things in real life, the tracking, ownership and commercialisation of models typically exists at the platform level. Whilst this has been fine in the past, there potentially exists with new advancements in technology, a pathway for existing 3D models to be reused, in a multitude of different environments. Much like digital photography with sites like shutterstock, the licensing and usage of this content sits with the platform, not with the author. Blockchain whilst being an effective architecture for immutable ownership does not provide the agility and speed for embedded asset ownership, where an asset resides within a platform.

In one embodiment, the system 10 or method would start by a MOC or Model Author uploading their model into a tool either locally via an app or via a network, which applies a unique identifier into the container of the model in an unreserved space. The fingerprint may include a backlink to a server which provides the collection of data. In this example, it expands the capability of massive existing MOC libraries by Extending MOC functionality to accommodate trending and tracking information. In the early days of the internet, tracking and big data was at its infancy. As Google started to monetise Adwords, the world was switched onto the power of understanding user behaviour via low level metadata collected as statistics. In this concept, the present invention would look to extend the MOC standard by building an EMOC data repository, where it trackers user behaviour on existing MOC libraries.

In another example, the present invention could ingest MOC models and create a new tagged file which could be called an EMOC. A MOC is a widely used data structure for Virtual LEGO models. A MOC structure may contain the necessary data and graphics that instructs a LEGO building technology how to build and present the model. In this concept, the system 10 of the present invention would look to Extend this MOC functionality where a Secondary data Structure could be created separate to the 10's of thousands of MOCS that already exist but intrinsically linked to the associated MOC.

As privacy is becoming a big problem for platforms, control of a user's privacy particularly children are becoming more and more restricted. As more and more time is being spent online, with the advent of new platforms like the Metaverse, more and more value will go into virtual worlds and more and more privacy data will be gathered and used in the virtual domain only. In one embodiment, the present invention may generate a new privacy model on an Avatar, thereby alleviating the complexities involved in a human's privacy being used online. The Avatar may be the virtual representation of the human, constantly being customised and upgraded and when online, can take ownership of many security or privacy issues. This way, the pervasive nature of the Avatar that exists across games in the platforms like the Meta Verse, a person could have a unique privacy locker and Avatar rights. It is clear that in the future, the investment into ones' Avatar will be huge and the Avatar will live across multiple domains. It may be appreciated that the application of an embodiment of the present invention may be used as a tool for Hyper personalisation, and privacy and usage data could be embedded into a cultured over time into each build.

It may be appreciated that in one embodiment of the present invention may provide a privacy model framework that can be use in a virtual or argument reality environment, which may be nested structure of data that could exist within a platform, a device, or a specific user account. This privacy framework could be encapsulated as a binary object or in any number of protected data fields inside a platform, device or asset. This may be called Emagineer Privacy Model Framework (EPMF), in which the EPMF is a metadata structure designed to contain media information for a presentation or control of a 3D or Virtual computer based object model in a framework that facilitates interchange, management, access control, and various presentations of the media or model. The control mechanisms could be directly linked to a blockchain in instances where speed is not critical and where the commercial costs are not a stumbling block.

In one embodiment, the control adhered to by the rules may be ‘local’ to the system containing the presentation, or may be via a network or other stream delivery mechanism. The framework may be structured into a data model, one which can be structured in a separate object-oriented model; a file can be decomposed into constituent objects very simply, and the structure or accessed as a set of rules in a control file or set of rules managed by technology in a remote network. The file format is designed to be independent of any particular network protocol while enabling efficient support for them in general.

The process may utilise an object-structured file organisation or framework structure. The Framework may be formed as a series of objects, called items in this specification. All data may be contained in items and there may be no other data within the file. This may include any initial signature required by the specific file format. All object-structured files conformant to this section of this specification (all Object-Structured files) shall contain a File Type Box. The framework may be contained in several files. One file may contain the metadata for the whole privacy mechanism, and is formatted to this specification. This file may also contain all the parent information data, relating specifically to the physical owner. The other files, or other items inside a complete framework is used to contain privacy data, and may also contain encrypted data, or other information. The framework or file may be structured as a sequence of objects and some of these objects may contain other objects.

The file structure may start with a Filetype Header. This may allow the receiving device, player or interpreter to parse correctly the information contained within the file. When not nested in a file, the filetype item purely provides a method to validate a request via an API or similar mechanism. Each item may contain a data structure that houses a number of different data fields for each parent item. For example, the Avatar box may contain any number of fields that relate to a unique virtual representation of a person and each unique data source can have a privacy, territory or control mechanism attached which allows the interpreter to access the field.

Naturally, a parsing mechanism needs to be developed as it is envisioned that this application be developed in house or any other number of methods created in which a 3rd party can develop a method in which qualified interrogation can happen and be measured as to certify that the data is not being misused. A quick description of the Filetype and Parent or Header items is listed below

### The File Type Item is to be EPMF

Object Structure: An object in this terminology is an item. Items start with a header which gives both size and type. The size is the entire size of the box, including the size and type header, fields, and all contained boxes. Each header describes the privacy item that enclosed data is related to.

Below is an overview of Header items
File Type Box
Definition
Box Type: “ftyp’
Value: EPMF
Mandatory: Yes

Quantity: Exactly one

This item must be placed as early as possible in the file (eg. After any obligatory signature, but before any significant variable-size items relating to privacy, such as Parent Name, Parent Age, Parent Key, Avatar Name, Avatar type, Original creator etc.
Parent Type Box
Definition
Box Type: “ptyp”
Value: EPMF
Mandatory: Yes
Quantity: Exactly one

This item must be placed straight after the file type box

These associated boxes relate directly to the Parent or Physical Owner or identity.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A system for generating a set of procedures for building a model with a set of inventory parts, the system comprising a processor for carrying out the steps of:
receiving a digital representation of an object;
applying an image recognition algorithm to detect one or more objects from the digital representation;
conducting artificial classification algorithm to classify each of the objects into a predetermined assembly, wherein the predetermined assembly is associated with a set of predetermined parts with a set of predetermined procedures;
determining a set of modification parts for the predetermined assembly;
substituting the set of modification parts with one or more inventory parts; and
generating a set of procedures by updating the set of predetermined procedures in accordance with the inventory parts.

2. The system according to claim 1, wherein the step of determining the set of modification parts comprises a step of identifying one or more predetermined parts not in the set of inventory parts.

3. The system according to claim 1, wherein the step of determining a set of modification parts comprises the steps of:
identifying one or more deviation sub-assemblies of the predetermined assembly;
calculating a deviation sub-assembly value of each of the deviation sub-assemblies;
adding a deviation sub-assembly in the set of modification parts when the deviation distance value of the deviation sub-assembly exceeds a threshold value.

4. The system according to claim 1, wherein the step of substituting the set of modification parts comprises the steps of:
connecting to an inventory database storing one or more inventory assemblies, wherein each of the inventory assemblies is associated with one or more inventory parts for building one or more inventory sub-assemblies in association with a set of inventory procedures;
conducting local classification algorithm to classify each of the modification parts into an inventory sub-assembly;
determining the inventory parts and a set of procedures for building the inventory sub-assembly.

5. The system according to claim 4, wherein the local classification algorithm comprises an unsupervised artificial neural network classification algorithm.

6. The system according to claim 4, wherein the local classification algorithm comprises a decision tree classification algorithm.

7. The system according to claim 4, wherein the inventory sub-assembly comprises one or more parts.

8. The system according to claim 4, wherein the inventory database is populated with user data by an end user.

9. The system according to claim 1, wherein the system comprises a server-side database for storing predetermined assembly, predetermined parts, and predetermined procedures.

10. The system according to claim 6, wherein the server-side database is populated by a service provider.

11. The system according to claim 6, wherein the artificial classification algorithm is trained with data retrieved from the server-side database.

12. The system according to claim 1, wherein the step of generating a set of procedures comprising the step of replacing a set of predetermined procedures associated with the modification parts with a set of inventory procedures associated with the inventory parts.

13. The system according to claim 1, wherein the object is animate, the processor further carries out the step of applying a motion pattern algorithm to detect and store movement of one or more animate objects prior to conducting artificial classification algorithm to classify each of the animate objects into a predetermined assembly.

14. The system according to claim 1,
wherein the processor is in communication with a Virtual Reality module.

15. The system according to claim 14, wherein the object is a virtual reality object, wherein the processor can carry out the step of applying a vision pattern algorithm to detect one or more virtual reality objects.

16. The system according to claim 15, wherein the virtual reality object is animate, the processor applies a motion pattern algorithm to detect one or more virtual reality animate objects.

17. The system according to claim 14,
wherein the processor can carry out the step of generating the set of procedures for building the model from the predetermined assembly of the virtual reality object.

18. The system according to claim 8, wherein the inventory database is populated with user data by a first end user and a second end user, for when the first end user and the second end user to build the model based on collective inventory parts.

19. The system according to claim 8, wherein the inventory database is populated with user data by a first end user and a second end user, wherein the system generates a set of procedures for building a first model for the first end user and for building a second model for the second user based on inventory parts of the first end user and the second end user respectively.

20. A system for generating a virtual reality representation of a predetermined assembly of a model from an object from reality into virtual reality, the system comprising a processor for carrying out the steps of:
receiving and conducting pre-processing of a digital representation of the object from reality;
applying a vision pattern algorithm to detect one or more objects from the digital representation;
conducting artificial classification algorithm to classify each of the objects into a predetermined assembly, wherein the predetermined assembly is associated with a set of predetermined parts from one or more inventory parts;
determining a set of modification parts for the predetermined assembly; and
connecting to a virtual reality module, wherein the predetermined assembly of the model by the one or more inventory parts is uploaded to the virtual reality module.

21. The system according to claim 20, wherein the object from reality is animate, the processor applies a motion pattern algorithm to record and detect the movement of the one or more animate objects.

22. The system according to claim 21, wherein the object is detected by the vision pattern algorithm to be a person, the predetermined assembly of the model is an avatar.

23. The system according to claim 22, wherein the object is detected by the vision pattern algorithm to be a person, the processor is configured to carry the step of connecting to an identity database storing user image data, wherein the processor is configured to cross-reference the user image data with the identity database for determining authorised usage of the avatar.

24. The system according to claim 23, wherein when the image of the person does not match the user's image, the processor is configured to carry out the step of seeking user authorisation of the person's image.

25. The system according to claim 24, wherein when the user has permission to use the person's image, the processor can carry out the step of generating the avatar of using the person's image.
